(19) United States
(12) Patent Application Publication
(10) Pub. No.: US 2023/0122639 A1
(43) Pub. Date: Apr. 20, 2023

(54) METHOD OF REDUCING SIZE OF MODEL FOR KNOWLEDGE TRACING

(71) Applicant: RIIID INC., Seoul (KR)

(72) Inventor: Kyu Seok KIM, Seoul (KR)

(73) Assignee: RIIID INC., Seoul (KR)

(21) Appl. No.: 17/968,095

(22) Filed: Oct. 18, 2022

(30) Foreign Application Priority Data
Oct. 20, 2021 (KR) 10-2021-0140032
Sep. 15, 2022 (KR) 10-2022-0116094

(51) Int. Cl. G06N 3/08; G06N 3/04; G09B 7/00

(52) U.S. Cl. CPC G06N 3/082; G06N 3/0454; G09B 7/00

(57) ABSTRACT

The present disclosure relates to a method of reducing a size of an artificial intelligence model by an electronic device, including: inputting an input value for training to a first model; training the first model for performing a specific task based on the input value; inputting the input value to a second model; and training the second model based on an output value of the first model, in which the first model may be an artificial intelligence model larger in size than the second model.

### CROSS-REFERENCE TO RELATED APPLICATION

This application claims priority to and the benefit of Korean Patent Application No. 10-2021-0140032, filed on Oct. 20, 2021, the disclosure of which is incorporated herein by reference in its entirety.

### BACKGROUND

### 1. Field of the Invention

The present disclosure relates to a method of reducing a model for a knowledge tracing task.

### 2. Discussion of Related Art

With the development of datasets and graphics processing units (GPUs), more complex models may be trained, and thus deep learning technology has made great strides. When applying the trained deep learning model to an actual service, not only the performance of the model, but also the size of the model is important. This is because models that are too large and complex may not operate efficiently in a small environment such as a mobile. Therefore, in order to solve this problem, recent studies have been made on a model reduction technique that reduces a size of a model, that is, the number of parameters.

Examples of techniques for reducing a size of a model may include knowledge distillation, pruning, quantization, and the like. In particular, the knowledge distillation was proposed by Professor Jeffrey Hinton in 2014, and is a technique for injecting knowledge of an already trained model (teacher model) into a model to be reduced in size (student model). However, the existing knowledge distillation technique has been limitedly used only for tasks such as image classification and translation.

### RELATED ART DOCUMENT

### Non-Patent Document

(Non-Patent Document 1) Distilling the Knowledge in a Neural Network, Geoffrey Hinton, Oriol Vinyals, Jeff Dean, 9, Mar., 2015

### SUMMARY OF THE INVENTION

The present disclosure is directed to implementing a lightweight module capable of increasing efficiency of a model by transferring knowledge of a large model to a small model.

In addition, the present disclosure is directed to applying a knowledge distillation technique to various tasks related to modeling of a student's knowledge state through a module for reducing a size of a model.

The technical objects to be achieved by the present disclosure are not limited to the technical objects described above, and other technical objects that are not described may be clearly understood by those with ordinary knowledge in the technical field to which the present disclosure belongs from the following description.

According to an aspect of the present disclosure, there is provided a method of reducing a size of an artificial intelligence model by an electronic device, including: inputting an input value for training to a first model; training the first model for performing a specific task based on the input value; inputting the input value to a second model; and training the second model based on an output value of the first model, in which the first model may be an artificial intelligence model larger in size than the second model.

The input value may include interaction information related to which question a student answers correctly.

The output value may be a probability value that the student answers the question correctly.

The training of the second model may be performed after a label of an output value of the second model is set to a label of the output value of the first model.

The training of the second model may include using a loss function based on the output value of the second model and the output value of the first model.

The method may further include providing a service for the specific task using the second model.

According to another aspect of the present invention, there is provided an electronic device for reducing a size of an artificial intelligence model, including: a communication module configured to communicate with a terminal; a memory; and a processor, in which the processor may input an input value for training to a first model, train the first model for performing a specific task based on the input value, input the input value to a second model, and train the second model based on an output value of the first model, and the first model may be an artificial intelligence model larger in size than the second model.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram for describing an electronic device related to the present disclosure;

FIG. 2 is a block diagram of an artificial intelligence (AI) device according to an embodiment of the present disclosure;

FIG. 3 is an example of a pipeline for an experiment of the DP-multi tasking learning (DP-MTL) model to which the present disclosure may be applied; and

FIG. 4 is an embodiment of an electronic device to which the present disclosure may be applied.

The accompanying drawings, which are included as part of the detailed description to help understanding of the present disclosure, provide embodiments of the present disclosure, and explain technical features of the present disclosure together with the detailed description.

### DETAILED DESCRIPTION OF EXEMPLARY EMBODIMENTS

Hereinafter, exemplary embodiments of the present disclosure will be described in detail with reference to the accompanying drawings. The same or similar components will be denoted by the same reference numerals regardless of the drawing numerals, and an overlapping description for the same or similar components will be omitted. In addition, terms “module” and “unit” for components used in the following description are used only to easily write the disclosure. Therefore, these terms do not have distinct meanings or roles by themselves. In addition, in describing the embodiment disclosed in the present disclosure, if it is determined that a detailed description of the related known art may obscure the gist of the embodiment disclosed in the present disclosure, the detailed description thereof will be omitted. Further, it should be understood that the accompanying drawings are provided only in order to allow exemplary embodiments of the present disclosure to be easily understood, and the spirit of the present disclosure is not limited by the accompanying drawings, but includes all the modifications, equivalents, and substitutions included in the spirit and the scope of the present disclosure.

Terms including ordinal numbers such as “first,” “second,”, and the like, may be used to describe various components. However, these components are not limited by these terms. The terms are used only to distinguish one component from another component.

It is to be understood that when one element is referred to as being “connected to” or “coupled to” another element, it may be directly connected or coupled to another element or connected or coupled to another element, having still another element intervening therebetween. On the other hand, it should be understood that when one element is referred to as being “directly connected to” or “directly coupled to” another element, it may be connected or coupled to another element without another element interposed therebetween.

Singular forms are intended to include plural forms unless the context clearly indicates otherwise.

It will be further understood that terms “include” or “have” used in the present specification specify the presence of features, numerals, steps, operations, components, parts mentioned in the present specification, or combinations thereof, but do not preclude the presence or addition of one or more other features, numerals, steps, operations, components, parts, or combinations thereof.

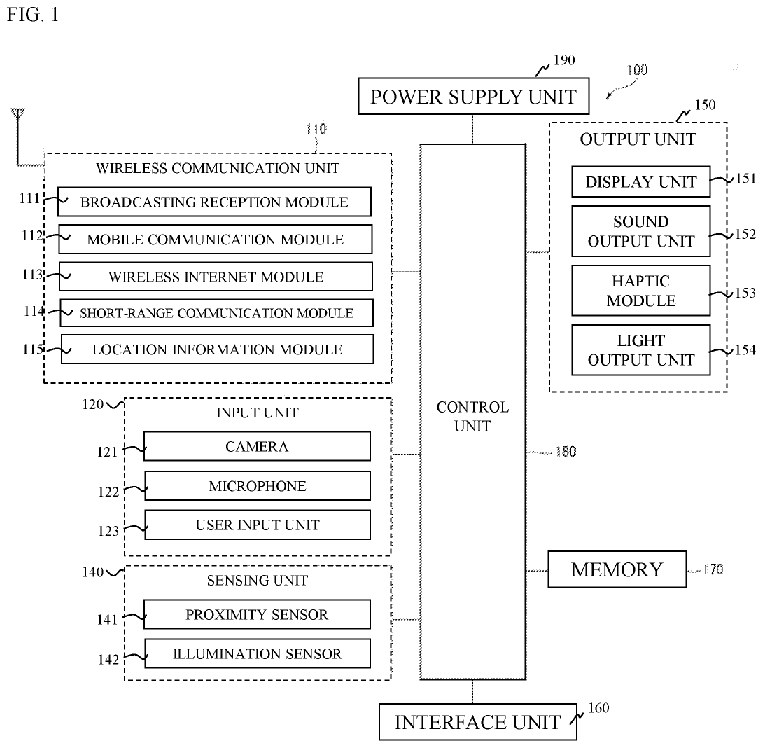

FIG. 1 is a block diagram for describing an electronic device related to the present disclosure.

An electronic device 100 includes a wireless communication unit 110, an input unit 120, a sensing unit 140, an output unit 150, an interface unit 160, a memory 170, a control unit 180, and a power supply unit 190, and the like. The components illustrated in FIG. 1 are not essential for implementing an electronic device, and the electronic devices described herein may have more or fewer components than those listed above.

More specifically, the wireless communication unit 110 of the components may include one or more modules which allow wireless communication between the electronic device 100 and a wireless communication system, between the electronic device 100 and other electronic devices 100, or the electronic device 100 and an external server. In addition, the wireless communication unit 110 may include one or more modules which connect the electronic device 100 to one or more networks.

The wireless communication unit 110 may include at least one of a broadcast receiving module 111, a mobile communication module 112, a wireless Internet module 113, a short range communication module 114, and a location information module 115.

The input unit 120 may include a camera 121 or an image input unit for inputting an image signal, a microphone 122 for inputting a sound signal, an audio input unit, or a user input unit 123 (for example, a touch key, a push key, and the like) for receiving information from a user. Voice data or image data collected by the input unit 120 may be analyzed and processed by a control command of a user.

The sensing unit 140 may include one or more sensors for detecting at least one of information in the electronic device, surrounding environment information surrounding the electronic device, and user information. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared sensor (IR sensor), a fingerprint sensor, an ultrasonic sensor, an optical sensor (e.g., see a camera 121), a microphone (see 122), a battery gauge, an environmental sensor (e.g., it may include at least one of a barometer, a hygrometer, a thermometer, a radiation detection sensor, a thermal detection sensor, a gas detection sensor, etc.), and a chemical sensor (e.g., an electronic nose, a healthcare sensor, a biometric sensor, etc.). Meanwhile, the electronic device disclosed in the present disclosure may use a combination of pieces of information detected by at least two or more of these sensors.

The output unit 150 is used to generate an output related to sight, hearing, tactile sense, or the like, and may include at least one of a display unit 151, a sound output unit 152, a haptic module 153, and an optical output unit 154. The display unit 151 forms a mutual layer structure with or is integrally formed with the touch sensor, thereby implementing a touch screen. The touch screen may function as the user input unit 123 which provides an input interface between the electronic device 100 and the user, and may provide an output interface between the electronic device 100 and the user.

The interface unit 160 serves as a path of various types of external devices connected to the electronic device 100. The interface unit 160 may include at least one of a wired/wireless headset port, an external charger port, a wired/wireless data port, a memory card port, a port for connection of a device including an identity module, an audio input/output (I/O) port, a video input/output (I/O) port, and an earphone port. In the electronic device 100, appropriate control related to the connected external device may be performed in response to the connection of the external device to the interface unit 160.

In addition, the memory 170 stores data for supporting various functions of the electronic device 100. The memory 170 may store a plurality of application programs or applications that are run by the electronic device 100, and data and instructions for operating the electronic device 100. At least some of these application programs may be downloaded from the external server via wireless communication. In addition, at least some of these application programs may be present on the electronic device 100 from the time of shipment for basic functions (for example, an incoming and outgoing call function, and a message reception and transmission function) of the electronic device 100. Meanwhile, the application program may be stored in the memory 170, installed on the electronic device 100, and run by the control unit 180 to perform the operation (or function) of the electronic device.

In addition to the operation related to the application program, the control unit 180 typically controls the overall operation of the electronic device 100. The control unit 180 may provide or process appropriate information or a function for a user by processing signals, data, information, and the like, which are input or output through the above-described components, or by running an application program stored in the memory 170.

In addition, the control unit 180 may control at least some of the components described with reference to FIG. 1 to run the application program stored in the memory 170. In addition, the control unit 180 may operate at least two or more of the components included in the electronic device 100 in combination with each other to run the application program.

The power supply unit 190 receives power from an external power source and an internal power source under the control of the control unit 180 and supply the received power to each component included in the electronic device 100. The power supply unit 190 includes a battery, which may be a built-in battery or a replaceable battery.

At least some of the components may cooperatively operate in order to implement the operation, control, or control method of the electronic device according to various embodiments described below. In addition, the operation, control, or control method of the electronic device may be implemented on the electronic device by running at least one application program stored in the memory 170.

In the present disclosure, the electronic device 100 may be collectively referred to as an electronic device.

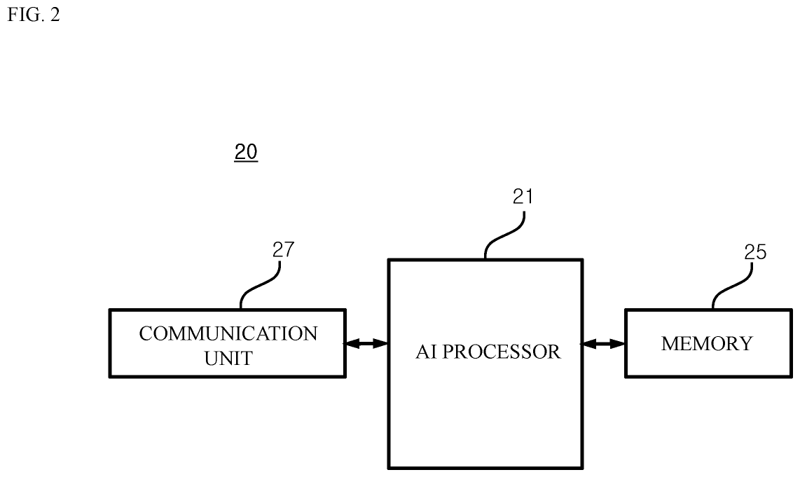

FIG. 2 is a block diagram of an artificial intelligence (AI) device according to an embodiment of the present disclosure.

The AI device 20 may include an electronic device including an AI module capable of performing AI processing, a server including the AI module, or the like. In addition, the AI device 20 may be included as at least a part of the electronic device 100 illustrated in FIG. 1 and may be provided to be performed in conjunction with at least some components of the electronic device 100 during AI processing.

The AI device 20 may include an AI processor 21, a memory 25, and/or a communication unit 27.

The AI device 20 is a computing device capable of learning neural networks, and may be implemented in various electronic devices such as a server, a desktop personal computer (PC), a notebook PC, and a tablet PC.

The AI processor 21 may learn the AI model using a program stored in the memory 25. In particular, the AI processor 21 may learn an AI model for performing a user knowledge tracing (KT) task.

For example, KT may model a student's knowledge state to track each individual's master state improvement in a domain under test. Before deep learning became popular, as a statistical model, item response theory (IRT) (Gonz′alez-Brenes, Huang, and Brusilovsky 2014; Khajah et al. 2014; Yudelson, Koedinger, and Gordon 2013; Pel'anek 2017; Gervet et al. 2020) and Bayesian knowledge tracing (BKT) were used to assess students' mastery of knowledge elements.

However, with the development of machine learning and deep learning, a time series-based approach to KT has been presented (Piech et al. 2015; Zhang et al. 2017; Choi et al. 2020).

Meanwhile, the AI processor 21 for performing the functions as described above may be a general purpose processor (for example, a central processing unit (CPU)), but may be an AI dedicated processor (for example, a graphics processing unit (GPU)) for AI learning.

The memory 25 may store various programs and data required for operation of the AI device 20. The memory 25 may be implemented by a non-volatile memory, a volatile memory, a flash memory, a hard disc drive (HDD), a solid state drive (SSD), or the like. The memory 25 is accessed by the AI processor 21, and readout/recording/correction/deletion/update, and the like, of data in the memory 25 may be performed by the AI processor 21. In addition, the memory 25 may store a neural network model (e.g., a deep learning model) generated through a learning algorithm for data classification/recognition according to an embodiment of the present disclosure.

Meanwhile, the AI processor 21 may include a data learning unit which learns a neural network for data classification/recognition. For example, the data learning unit acquires learning data to be used for learning, and applies the obtained learning data to the deep learning model, thereby making it possible to train the deep learning model.

The communication unit 27 may transmit the AI processing result by the AI processor 21 to an external electronic device.

Here, the external electronic device may include other terminals and servers.

Meanwhile, although the AI device 20 illustrated in FIG. 2 has been described as functionally divided into the AI processor 21, the memory 25, the communication unit 27, and the like, the above-described components may be integrated into one module and called an AI module.

A very simple way to improve the performance of most machine learning algorithms is to train many different models on the same data and then average the predictions of these models. However, making the prediction using such a model ensemble is cumbersome and increases computational cost. A technique of distilling the knowledge in a neural network is a technique to solve this problem.

Distillation

A neural network may calculate a class probability using a “softmax (softlayer)” output layer that generally converts logit zᵢ, compares zᵢ with other logits, and calculates a probability qi of each class.

The following Equation 1 is an example of calculating qi.

$${q}_{i} = \frac{exp ( {z}_{i} / T )}{{\sum }_{j} exp ( {z}_{j} / T )} \qquad [ Equation 1 ]$$

Referring to Equation 1, T denotes a temperature generally set to 1, and when a larger value is used for T, a probability distribution for the class may become softer.

In the simplest form of distillation, knowledge may be transferred to the distilled model by 1) training the distilled model (student model) with a transfer set, and 2) using the high-temperature softmax in a cumbersome model (teacher model) and using a soft target distribution of each case in the generated transfer set. The same high temperature may be used in the training of the distilled model, but the temperature may be set to 1 after the training.

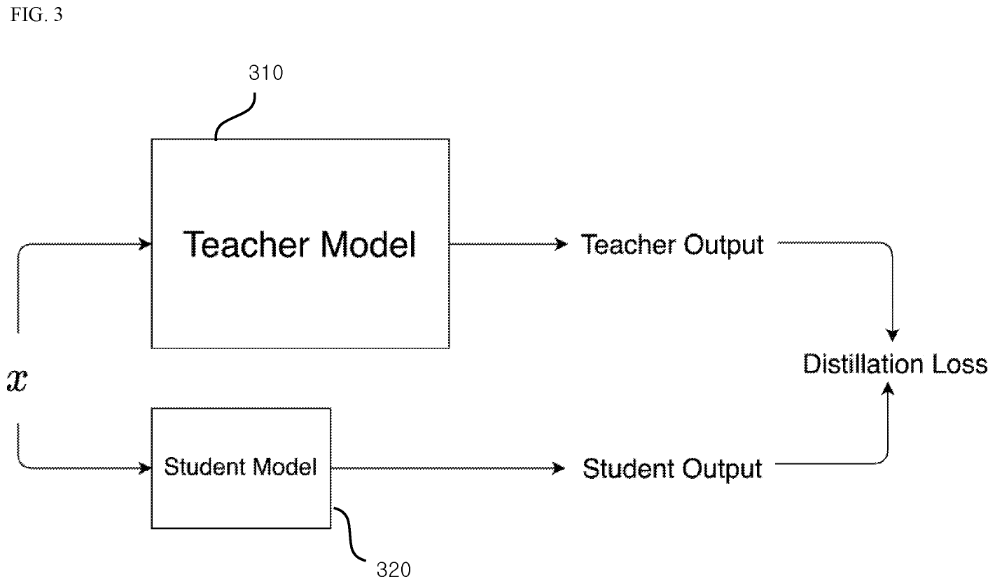

FIG. 3 illustrates an example of a module for reducing a size of a model to which the present disclosure can be applied.

In general, when performing tasks such as KT and dropout prediction, transformer-based models may be used. However, large models used in these tasks occupy a lot of memory and have a slow inference speed.

Referring to FIG. 3, the electronic device may use the knowledge distillation technique to transfer knowledge of a pre-trained large model (teacher model) to a small model (student model). As a result, the electronic device may quickly and efficiently perform the KT and the dropout prediction with a smaller model.

The electronic device may include a teacher model 310 and a student model 320. For example, the teacher model 310 may have a larger size than the student model 320. In more detail, the teacher model 310 may include 256 hidden dimensions and 2 layers, and the student model 320 may include 32 hidden dimensions and 1 layer.

The electronic device may input interaction-related data (x) related to a problem solved by a user to the pre-trained teacher model 310 and the small student model 320. For example, when a user answers a question correctly, the interaction may have a value of 1, otherwise the interaction may have a value of 0. In addition, the interaction matrix that may be generated in this way may include interaction-related data about a question that does not have a label before simulation.

The electronic device compares a teacher output and a student output, which are output values for an input value x of each model, and trains the student model 320 through a distillation loss function, thereby transferring the knowledge of the teacher model 310 to the student model 320. In more detail, the electronic device may use the output value of the teacher model 310 as a label of the student output of the student model 320 to train the student model 320 so that the output value of the student model 320 approximates the output value of the teacher model 310 with respect to the input value x.

For example, in the task of classifying an animal picture, when a picture of a cat is an input value, it may be assumed that the pre-trained teacher model 310 has a result that the probability that the corresponding picture is a cat is 80% and the probability that the corresponding picture is a dog is 20%. The electronic device trains the student model 320 so that the student model 320 also has a result that the probability that the corresponding picture is a cat is 80% and the probability that the corresponding picture is a dog is 20%, thereby injecting the knowledge of the teacher model 310.

As a result, the electronic device in the present disclosure may perform modularization so that the knowledge distillation can be commonly used in all coding repositories (e.g., KT repository, dropout prediction repository). Also, since the KT and the dropout prediction may be shared with the same knowledge distillation code, the knowledge distillation may be applied to several possible tasks. In other words, even when any new task modeling a student's state is input, it is possible to perform modularization that may apply the knowledge distillation to the task as well.

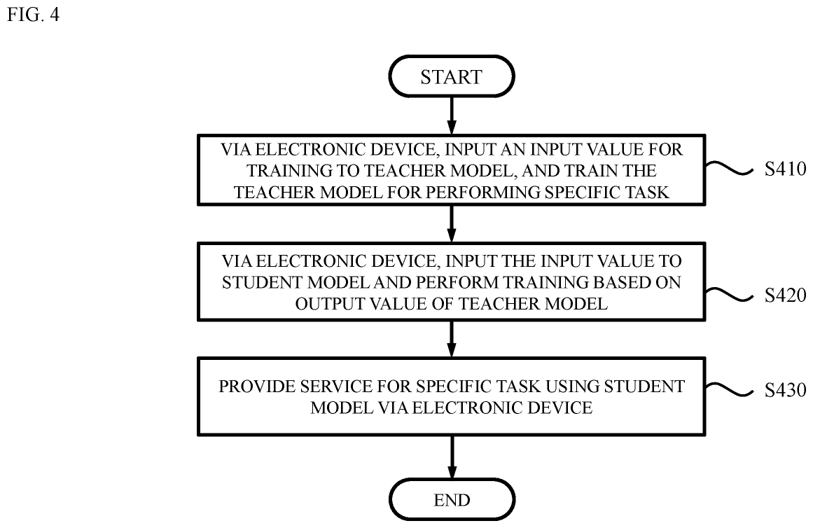

FIG. 4 is an embodiment of reducing a size of a model to which the present disclosure may be applied.

Referring to FIG. 4, the electronic device may perform the lightweight and modularization of the model of FIG. 3.

The electronic device inputs an input value for training to the teacher model, and trains the teacher model for performing a specific task (S410). For example, the input value may be interaction information (e.g., student's skill level, selected answer, score, correct answer or not) about which question the student answers correctly. Also, a specific task may be the probability that the student answers a question correctly in the corresponding interaction. In this case, the trained teacher model may predict the probability that the student answers a question correctly as 80%.

The electronic device inputs an input value to the student model, and performs training based on an output value of the teacher model (S420). For example, the output value of the teacher model is set as a label of an output value of the student model, and thus, the training may be performed. In more detail, the student model may be trained so that the probability that the corresponding student answers a question correctly is predicted to be 80% from the corresponding input value in the same manner as the teacher model. To this end, a distillation loss for comparing the output value of the teacher model and the output value of the student model may be used.

The electronic device provides a service for a specific task by using the student model (S430). For example, the electronic device may provide a service to the user through the user terminal.

As a result, the electronic device may proceed at a faster speed when performing the KT and the dropout prediction in a real mobile production environment. In addition, according to the present disclosure, it is possible to improve memory efficiency by reducing the size of the model. In addition, it is possible to perform more efficient training by increasing the training speed of the model.

The present disclosure described above enables the program to be embodied as computer readable code on a medium on which the program is recorded. A computer readable medium may include all kinds of recording devices in which data that may be read by a computer system is stored. An example of the computer readable medium may include a hard disk drive (HDD), a solid state disk (SSD), a silicon disk drive (SDD), a read only memory (ROM), a random access memory (RAM), a compact disc-read only memory (CD-ROM), a magnetic tape, a floppy disk, an optical data storage, and the like, and also include a medium implemented in the form of a carrier wave (for example, transmission through the Internet). Therefore, the above-mentioned detailed description is to be interpreted as being illustrative rather than being restrictive in all aspects. The scope of the present disclosure should be determined by reasonable interpretation of the appended claims, and all changes within the equivalent scope of the present disclosure are included in the scope of the present disclosure.

According to an embodiment of the present disclosure, it is possible to increase the efficiency of a model by transferring knowledge of a large model to a small model.

In addition, according to an embodiment of the present disclosure, it is possible to apply a knowledge distillation technique to various tasks related to modeling of a student's knowledge state through a module for reducing a size of a model.

Effects which can be achieved by the present disclosure are not limited to the above-described effects. That is, other effects that are not described may be obviously understood by those skilled in the art to which the present disclosure pertains from the above detailed description.

In addition, although the services and embodiments have been mainly described hereinabove, this is only an example and does not limit the present disclosure. Those skilled in the art to which the present disclosure pertains may understand that several modifications and applications that are not described in the present specification may be made without departing from the spirit of the present disclosure. For example, each component described in detail in an exemplary embodiment of the present invention may be modified. In addition, differences associated with these modifications and applications are to be interpreted as being included in the scope of the present disclosure as defined by the following claims.

What is claimed is:

1. A method of reducing a size of an artificial intelligence model by an electronic device, the method comprising:
inputting an input value for training to a first model;
training the first model for performing a specific task based on the input value;
inputting the input value to a second model; and
training the second model based on an output value of the first model,
wherein the first model is an artificial intelligence model larger in size than the second model.

2. The method of claim 1, wherein the input value includes interaction information related to which question a student answers correctly.

3. The method of claim 2, wherein the output value is a probability value that the student answers the question correctly.

4. The method of claim 3, wherein the training of the second model is performed after a label of an output value of the second model is set to a label of the output value of the first model.

5. The method of claim 4, wherein the training of the second model includes using a loss function based on the output value of the second model and the output value of the first model.

6. The method of claim 5, further comprising providing a service for the specific task using the second model.

7. An electronic device for reducing a size of an artificial intelligence model, the electronic device comprising:
a communication module configured to communicate with a terminal;
a memory; and
a processor,
wherein the processor inputs an input value for training to a first model,
trains the first model for performing a specific task based on the input value,
inputs the input value to a second model, and
trains the second model based on an output value of the first model, and
the first model is an artificial intelligence model larger in size than the second model.

8. The electronic device of claim 7, wherein the input value includes interaction information related to which question a student answers correctly.

9. The electronic device of claim 8, wherein the output value is a probability value that the student answers the question correctly.

10. The electronic device of claim 9, wherein the training of the second model is performed after a label of an output value of the second model is set to a label of the output value of the first model.

11. The electronic device of claim 10, wherein the training of the second model uses a loss function based on the output value of the second model and the output value of the first model.

12. The electronic device of claim 11, wherein the processor uses the second model to provide a service for the specific task through a terminal.
